(19) United States
(12) Patent Application Publication
(10) Pub. No.: US 2005/0253552 A1
(43) Pub. Date: Nov. 17, 2005

(54) Power supply apparatus for digital information device

(76) Inventor: Heng-Chung Wu, Hsin Feng Hsiang (TW)

Correspondence Address: BIRCH STEWART KOLASCH & BIRCH, PO BOX 747, FALLS CHURCH, VA, 22040-0747, US

(21) Appl. No.: 10/843,467

(22) Filed: May 12, 2004

(51) Int. Cl. H02J 7/35

(52) U.S. Cl. 320/101

(57) ABSTRACT

A power supply apparatus for digital information device includes a solar cell. The solar cell has an output connected to a charging module in the digital information device. The solar cell can charge at least one rechargeable battery of the digital information device to extend the workable time of the digital information device.

### FIELD OF THE INVENTION

The present invention relates to a power supply apparatus for digital information device, especially to a power supply apparatus converting light energy to electric energy and supplying the electric energy to the digital image device.

### BACKGROUND OF THE INVENTION

The conventional digital image devices such as digital still cameras (DSC) and digital video cameras (D8) generally have the restriction of limited battery life.

Therefore, the conventional digital image devices are generally provided with charging module to charge at least one rechargeable battery therein. However, the workable hour for the recharged battery is still limited and the rechargeable times of the rechargeable battery is also limited.

### SUMMARY OF THE INVENTION

It is an object of the present invention to provide a power supply apparatus for digital image device, wherein the power supply apparatus converts light energy to electric energy and supplies the electric energy to the digital image device, whereby the charging time and numbers of the rechargeable battery are reduced.

It is another object of the present invention to provide a power supply apparatus for digital image device, wherein the power supply apparatus converts light energy to electric energy and directly supplies the electric energy to the digital image device.

To achieve above object, the present invention provides a power supply apparatus for digital information device. The power supply apparatus includes a battery unit capable of converting light energy into electrical energy. The battery unit has an output connected to a charging module in the digital information device. The battery unit can be a solar cell, and the digital information device can be digital still camera (DSC), digital video camera (D8), personal digital assistance (PDA), smart phone, or digital camera of mobile phone etc.

The various objects and advantages of the present invention will be more readily understood from the following detailed description when read in conjunction with the appended drawing, in which:

### BRIEF DESCRIPTION OF DRAWING

FIG. 1 shows a block diagram of a digital image device according to the present invention; and

FIG. 2 shows the flowchart of the present invention.

### DETAILED DESCRIPTION OF THE INVENTION

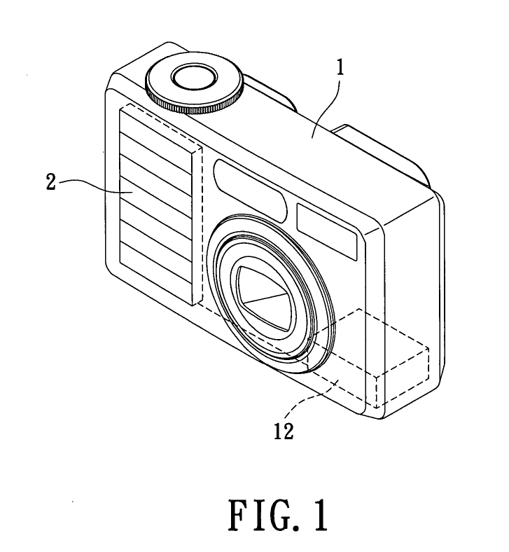

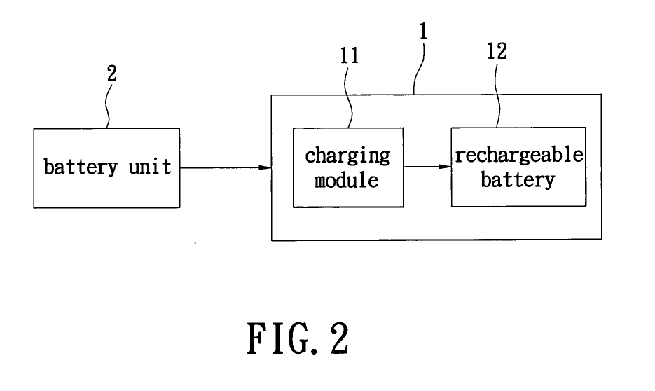

FIG. 1 shows a perspective view of a digital image device with a power supply apparatus according to the present invention. FIG. 2 shows a block diagram of the power supply apparatus according to the present invention. The power supply apparatus according to the present invention comprises a digital information device 1 and a battery unit 2 capable of converting light energy into electrical energy.

In the present invention, the digital information device can be digital still camera (DSC), digital video camera (D8), personal digital assistance (PDA), smart phone, or digital camera of mobile phone etc. The digital image device has a charging module 11 to charge a rechargeable battery 12 connected thereto.

In the present invention the battery unit 2 is a solar cell and connected to the charging module 11. The solar cell is manufactured by semiconductor process and is able to convert light energy to electrical energy.

More particularly, the solar cell comprises p-type and n-type semiconductor for generating electron and hole pair when receiving sunshine. The electron and hole pair is separated to produce voltage drop. The voltage drop is supplied to the charging module 11 and then the electrical power is supplied by the charging module 11 to charge the rechargeable battery 12.

The digital information device 1 can conveniently get electrical power from the charging module 11, wherein the battery unit 2 supplies electrical power to the charging module 11. The stand-by and workable time of the digital information device 1 can be extended. Moreover, the charging time and numbers of the rechargeable battery 12 are reduced.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A power supply apparatus for digital information device, comprising
a charging module in the digital information device and used to charge a rechargeable battery in the digital information device;
a battery unit capable of converting light energy to electrical energy and connected to the charging module;
whereby the battery unit supplies electrical power to the rechargeable battery through the charging module when the battery unit receives a sunshine.

2. The power supply apparatus for digital information device as in claim 1, wherein the battery unit is a solar cell.

3. The power supply apparatus for digital information device as in claim 1, wherein the battery unit produces a DC electrical power, and the DC electrical power is stored and then supplied to the charging module.

4. The power supply apparatus for digital information device as in claim 1, wherein the digital information device can be one of digital still camera (DSC), digital video camera (D8), personal digital assistance (PDA), smart phone, and digital camera of mobile phone.
